(19) United States
(12) Patent Application Publication
(10) Pub. No.: US 2018/0026705 A1
(43) Pub. Date: Jan. 25, 2018

(54) COMMUNICATIONS SYSTEM FOR USE WITH UNMANNED AERIAL VEHICLES

(71) Applicant: ROCKY MOUNTAIN EQUIPMENT CANADA LTD., Calgary (CA)

(72) Inventors: Curtis PARKS, Ottawa (CA); Chris POLOWICK, Ottawa (CA)

(21) Appl. No.: 15/547,202

(22) PCT Filed: Jan. 29, 2016
(86) PCT No.: PCT/CA2016/050077

§ 371 Date: Jul. 28, 2017

Related U.S. Application Data
(60) Provisional application No. 62/109,318, filed on Jan. 29, 2015.

(51) Int. Cl. H04B 7/185; G05D 1/00; G08G 5/00; B64C 39/02

(52) U.S. Cl. CPC H04B 7/18506; B64C 39/024; G05D 1/0022; G08G 5/0013; B64C 2201/146

(57) ABSTRACT

Systems, methods, and devices relating to a communications system for use with unmanned aerial vehicles. The communications system is equipped with a controller/processor, a satellite-based communications module, and an RF-based communications module. Both communications modules are coupled to an autopilot module and to sensor modules so that commands can be received by the autopilot module from the communication modules. As well, the flight characteristics can be received from the sensor modules and can be transmitted to a base station by way of the communications modules. For short to medium range missions, the RF-based communications module is active with the satellite based communications module providing a backup communications link. For medium to long rage missions, the satellite based communications module is active and the base station and the UAV communicate by way of this module.

### TECHNICAL FIELD

The present invention relates to unmanned aerial vehicles (UAVs). More specifically, the present invention relates to methods, systems, and devices relating to communications between a ground station and an operating UAV.

### BACKGROUND

The rise in the use of UAV has led to a myriad of uses for this technology. Its military applications are infamous and well-known while its more mundane applications continuously increase in number. Unfortunately, due to the line-of-sight requirements that some UAVs have, this limits their applications. Current and future UAVs will be able to undertake beyond line of sight (BLOS) missions as UAVs increase their operational range. One potential problem with such BLOS missions is the need for communications with the UAV. As the operator loses sight of the UAV, control of (and therefore communications with) the UAV must be maintained at all times.

Preferably, such communications with the UAV are available at all times and are uninterruptible as interrupted remote control of the UAV may lead to a catastrophic failure of the vehicle. As well, it is preferred that the communications system be cost-effective. Such preferences may become requirements as the transportation agencies of various countries (including the US's FAA and Canada's Transport Canada) may require that communications with UAVs be uninterruptible for BLOS missions.

Current communications systems for UAVs involve line-of-sight RF (radio frequency) systems. However, these RF-based systems are fraught with issues, not least of which is their limited range.

It is therefore an object of the present invention to mitigate if not overcome the shortcomings of the prior art and to thereby provide a command and control communications system that is effective for BLOS missions for UAVs.

### SUMMARY

The present invention provides systems, methods, and devices relating to a communications system for use with unmanned aerial vehicles. The communications system is equipped with a controller/processor, a satellite-based communications module, and an RF-based communications module. Both communications modules are coupled to an autopilot module and to sensor modules so that commands can be received by the autopilot module from the communication modules. As well, the flight characteristics can be received from the sensor modules and can be transmitted to a base station by way of the communications modules. The controller/processor controls which communication modules are active at any point in time. For short to medium range missions, the RF-based communications module is active with the satellite based communications module providing a backup communications link. For medium to long rage missions, the satellite based communications module is active and the base station and the UAV communicate by way of this module. The actual satellite-based link is, however, only active when active communications between the base station and the UAV are occurring. Otherwise, the satellite based link is inactive.

In a first aspect, the present invention provides a system for communications between an unmanned vehicle and a base station, the system comprising:
a first communications module for communicating with said base station using a radio-frequency (RF) link;
a second communications module for communicating with said base station using a satellite-based link;
a controller for activating and deactivating any of said first and second communications modules;

wherein at least one of said communications modules is active at any one time.

In a second aspect, the present invention provides a method for controlling an unmanned vehicle from a remote base station, the method comprising:

a) receiving, at said vehicle, commands for controlling said vehicle;

b) passing said commands to a control module on said vehicle;

wherein

said commands are received by way of either a first communications module for communicating between said base station and said vehicle using a radio frequency (RF) link or a second communications module communicating between said base station and said vehicle using a satellite-based link.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of an environment in which the present invention may be used;

FIG. 2 is a block diagram of a portion of a command and communications system according to one aspect of the invention; and

FIG. 3 is a block diagram illustrating the connections in a data network connecting the various systems in a vehicle using one aspect of the present invention.

### DETAILED DESCRIPTION

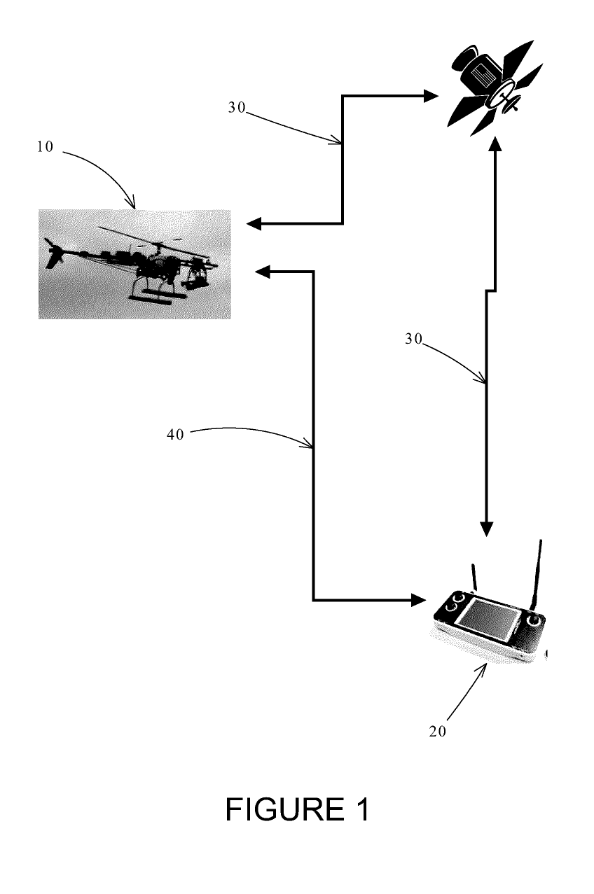

Referring to FIG. 1, a block diagram of the environment in which the present invention may be used is illustrated. As can be seen, a UAV 10 is in communications with and is controlled by a base station 20. In one aspect of the invention, the UAV 10 communicates with the base station 20 by way of a satellite-based link 30 or by way of an RF-based link 40.

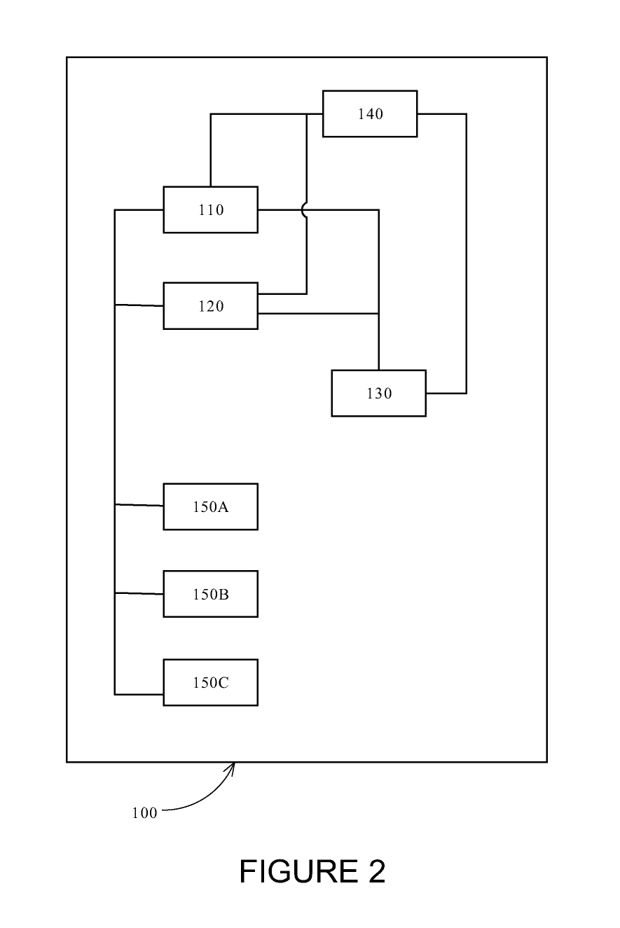

Referring to FIG. 2, a block diagram of a portion of a command and communications system for a UAV is illustrated. From the figure, the system 100 includes a satellite-based communications module 110, an RF-based communications module 120, an autopilot module 130, a controller 140, and multiple sensor modules 150A, 150B, 150C. The two communications modules 110, 120 are both coupled to the autopilot module 130 as well as to the controller 140. The autopilot module 130 is capable of receiving commands from either of the communications modules 110, 120. Both these communications modules 110, 120 are also coupled to the sensor modules 150A-150C and are capable of receiving data from these sensor modules for transmission to the base station 20. The controller 140 determines which of the communications modules 110, 120 are active and transmitting to the base station 20. In one implementation, the autopilot module 130 is coupled to the communications modules 110, 120 by way of the controller 140. Other configurations by which the other modules are coupled to the communications modules by way of the controller are, of course, possible.

It should be noted that, depending on the configuration, the base station 20 may also be equipped with a controller that operates to manage communications between the base station and the UAV 10. Such a controller on the base station would operate to interpret and direct communications between the UAV and the rest of the base station communications circuitry and software.

For take-offs and landings, given the large volume of data needed from the sensors, the controller 140 uses the RF-based communications module for communicating with the base station. For shorter range missions, such as missions where the UAV is within sight of the base station (and operator), the RF-based communications module is used. When the RF-based communications module is used, the satellite-based communications module can be used as a backup communications link with the base station. If the RF-based module fails or if the RF-based module is in use and communications is lost between the UAV and the base station, the controller can be configured to automatically switch to the satellite-based module. This can prevent loss of control of the UAV.

For longer range missions, such as those of medium to long range distances (e.g. beyond line of sight missions), the controller activates the satellite-based module for communications. At these ranges, the satellite based module is active and all communications between the base station and the UAV are routed through the satellite based module. To optimize the use of such a satellite based link, the link is inactive until required. To accomplish this, a link is not established between the UAV, the satellite, and the base station until the UAV or the base station requires such as a link. When such a link is required, the link is established and data to and/or from the UAV is exchanged with the base station. Once the transmission is complete, the link is terminated. By using such a protocol, the use of costly satellite based communications is minimized. The operator, instead of paying for a constantly open or active link, only pays for the satellite link on a per message or a per use basis.

Preferably, the satellite-based module is coupled to a modem capable of sending short-burst data so that all communications between the satellite and the UAV are accomplished on a burst mode basis.

It should be noted that the controller automatically switches from the RF-based module to the satellite-based module as the UAV is operating. This can be done by the controller continuously sampling the signal quality between the base station and the RF-based communications module. When the signal quality is degraded past a certain threshold or when the radio signal times out, the controller automatically switches to the satellite-based module for communications. If the signal quality recovers (e.g. when the UAV is heading back towards the base station), the controller also automatically switches from the satellite-based link to the RF-based link. Of course, it should be clear that, as noted above, the satellite-based link is not constantly active. If communications between the UAV and the base station is required and the RF-based link is unavailable or has its signal quality too degraded, then the controller will route all communications to the satellite-based communications module. The actual satellite link will only be activated when the message to be transmitted is ready for transmission in burst mode.

In one implementation, the base station has the ability to force the UAV to exclusively use the satellite link. The user at the base station operating the remote control for the UAV can force the UAV to exclusively use the satellite link even if the RF link is still within its operational range (usually about 10 km).

To further enhance the use of the communications system, whether satellite based or RF-based, telemetry information, ADS-B (automatic dependent surveillance-broadcast) information, as well as autopilot commands, are transmitted to and from the UAV using the communications system. This means that sensor readings, weather information around the UAV, as well as the location, altitude, and velocity of the UAV, are all transmitted from the UAV to the base station. This data can then be retransmitted from the base station or be saved for later analysis. In addition to this, the communications system also acts as a VHF radio bridge. Radio communications between the UAV and surrounding aircraft can be transmitted from and be received by the UAV. The operator at the base station can communicate to aircraft in the vicinity of the UAV as if the operator were on the UAV. Voice transmissions received by the UAV from surrounding aircraft are digitized and transmitted to the base station either by the satellite-based link or the RF-based link. The operator at the base station can then listen to these voice transmissions. The operator's voice response, at the base station, are then digitized and transmitted to the UAV using the operative communications link. Once received by the UAV, this response is then retransmitted to the surrounding aircraft.

The above capability allows the UAV to be controlled and operated in a manner similar to manned aircraft as the operator can communicate with surrounding air traffic and can view ADS-B information being received from the UAV's ADS-B beacon. In addition to these advantages, the UAV can even transmit or receive NOTAMs (Notice to Airmen) to alert surrounding aircraft of any potential issues in the vicinity.

It should be noted that the RF-based link is, preferably, a high bandwidth link. The various aspects of the invention may be used in devices other than UAVs. As an example, other unmanned vehicles may also use the invention. As well, other remotely controlled systems which may need to operate beyond line of sight of a controlling base station may use this and other variants of the invention.

In one implementation, a Microhard nIP 921 radio modem was used for the RF link. However, any serial port bridge device may be used in this implementation. For the satellite link, one implementation uses an Iridium-based satellite modem. In terms of a controller/processor, this implementation uses a PC-104 type controller. Other processors and controllers are, of course, possible. Such controllers are, preferably, ruggedized and configured for the aerial environment in which it will be operating.

The software operating on the UAV can also have a number of useful features. Specifically, the UAV software can be configured to mimic the autopilot protocols and to intercept the autopilot messages before these are sent to the base station. These messages are then sent to the base station through the RF link. While this is occurring, the software also controls the transmission rate of the telemetry to the base station. The transmission rate is determined based on the capabilities of the satellite link. As well, the software prioritizes between the various messages to be sent to the base station with the higher priority messages being transmitted first. Such high priority messages may include low battery state warnings, autopilot sensor failure warnings, and ADS-B tracks for nearby aircraft.

The software on the UAV also provides data integrity checks on data to be transmitted to the ground station. Checksums for these integrity checks are transmitted to the base station so that the data received can be verified for correctness. To ensure that messages from the base station are not duplicated, message IDs of messages received by way of the satellite link are checked against message IDs of messages received by way of the RF link. This ensures that there is no duplication of messages received.

It should be noted that the UAV software cooperates with the software operating at the base station. Similar to the UAV software, the base station software also controls which communications link is to be used. The base station software automatically sends communications to the UAV by way of the satellite link in the event the RF link times out. As well, if the UAV fails to acknowledge receipt of a transmission which the base station has already sent, this transmission is re-sent by way of the satellite link using the same message ID. This ensures that no duplication of messages is made.

In one implementation, to ensure that telemetry is always received properly, telemetry values are sent to the base station by way of the satellite link, even if the RF link is active. To also ensure that the satellite link is working properly before the RF link becomes inactive, telemetry values received by way of the satellite link is displayed to the user at the base station. This way, the user can confirm that the telemetry is correct and that the satellite link is working properly before the UAV leaves the range of the RF link.

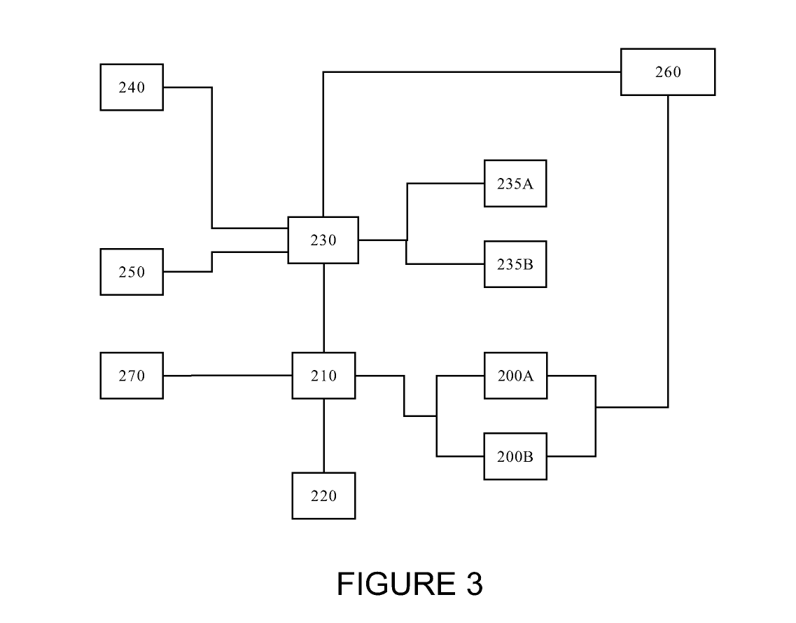

In one implementation, the communications system on the UAV is connected to the various subsystems by way of a data network. Referring to FIG. 3, a block diagram of such a data network on a UAV is illustrated. The communications system modules (an RF communications module 200A and a satellite communications module 200B) are coupled to a network switch 210. The network switch 210 also couples a LiDAR module 220 and a GPS interface 230. The GPS interface interfaces with at least one GPS subsystem (GPS subsystems 235A and 235B in FIG. 3) and produces a single GPS timing signal which is used by all the other subsystems on-board the UAV, including the sensor subsystems (e.g. the LiDAR module). By way of the GPS interface, a camera module 240 is coupled to or at least addressable by the various subsystems of the UAV. Also coupled to the GPS interface to receive the single GPS signal is an inertial measurement unit (IMU) module 250 and an autopilot module 260. As noted above, the autopilot module 260 can receive commands from either of the communications modules 200A, 200B. The GPS interface's single GPS signal can be used to trigger the camera module 240 or the LiDAR module 220. Other payload and/or sensors 270 can also be coupled to the switch 210. As noted above, in one implementation, the autopilot module may communicate with the communications modules by way of a controller. Similarly, depending on the configuration, the other modules may be coupled to the controller to communicate with at least the communications modules.

The network illustrated in FIG. 3 can be implemented as a local area network (LAN) on board the UAV. In one implementation, an Ethernet network connects the LiDAR module 220 with the GPS interface 230 and the communications modules 200A, 200B. This allows a user to query whether the payloads (e.g. the camera, the LiDAR, and the other payloads/sensors) are operating even when the UAV is airborne. Such queries would not require a lot of bandwidth and, as such, this can be implemented even if the RF communications module only allows for a low bandwidth data connection to the base station.

The single GPS signal used by the various modules can take the form of an extremely accurate timing pulse that gets sent once per second (a PPS signal). In one implementation, a serial communication interface is used by the various modules to communicate with the GPS interface. This serial interface allows any of the modules to communicate with the GPS interface and request different types of data. The serial communication interface allows the modules to request whatever data they require (e.g. UAV position, heading, IMU data, etc.).

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g. “C”) or an object-oriented language (e.g. “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for communications between an unmanned vehicle and a base station, the system comprising:
a first communications module for communicating with said base station using a radio-frequency (RF) link;
a second communications module for communicating with said base station using a satellite-based link;
a controller for activating and deactivating any of said first and second communications modules;
wherein at least one of said communications modules is active at any one time.

2. A system according to claim 1, wherein said controller activates said second communications module when said RF link is unusable due to being out of range.

3. A system according to claim 1, wherein said second communications module is used as a backup to said first communications module.

4. A system according to claim 1, wherein communications between said vehicle and said base station comprises sensor readings for an environment surrounding said vehicle.

5. A system according to claim 1, wherein communications between said vehicle and said base station comprises voice communications received by said vehicle from other vehicles in an area surrounding said vehicle.

6. A system according to claim 1, wherein communications between said vehicle and said base station comprises voice communications to be transmitted by said vehicle to other vehicles in an area surrounding said vehicle.

7. A system according to claim 1, wherein communications between said vehicle and said base station comprises commands for controlling said vehicle.

8. A system according to claim 1, wherein said satellite based link is only active when communications are being received or transmitted.

9. A system according to claim 1, wherein said system is coupled to other subsystems on said vehicle by way of a local data network on said vehicle.

10. A system according to claim 9, wherein said other subsystems include at least one of: a camera module, a LIDAR module, and a GPS interface.

11. A system according to claim 10, wherein said GPS interface produces a single GPS timing signal used by said other subsystems for timing events for which at least one of said other subsystems is triggered.

12. A system according to claim 11, wherein said single GPS timing signal is produced using at least two GPS antennas located at different points on said vehicle.

13. A method for controlling an unmanned vehicle from a remote base station, the method comprising:
a) receiving, at said vehicle, commands for controlling said vehicle;
b) passing said commands to a control module on said vehicle;
wherein
said commands are received by way of either a first communications module for communicating between said base station and said vehicle using a radio frequency (RF) link or a second communications module communicating between said base station and said vehicle using a satellite-based link.

14. A method according to claim 13, wherein a controller on said vehicle switches between said first communications module and said second communications module when said vehicle is beyond an effective range of said RF link.

15. A method according to claim 13, wherein a controller on said vehicle uses said second communications module as a backup to said first communications module.

16. A method according to claim 13, further comprising the step of switching from using said RF link to said satellite-based link when said RF link is no longer available due to range limitations of said RF link.

17. A method according to claim 13, further comprising the step of receiving voice communications from said base station and passing said voice communications to aircraft in a surrounding area.

18. A method according to claim 13, further comprising the step of receiving voice communications from aircraft from a surrounding area and passing said voice communications to said base station.

19. A method according to claim 13, further comprising the step of gathering sensor readings for an environment surrounding said vehicle and transmitting said readings to said base station.
